(19) United States
(12) Patent Application Publication
(10) Pub. No.: US 2013/0254290 A1
(43) Pub. Date: Sep. 26, 2013

(54) METHOD AND SYSTEM FOR PROVIDING CONTENT TO A USER

(71) Applicant: NIATERRA NEWS INC., New York, NY (US)

(72) Inventor: Jordan Ian Grossman, New York, NY (US)

(73) Assignee: NIATERRA NEWS INC., New York, NY (US)

(21) Appl. No.: 13/847,726

(22) Filed: Mar. 20, 2013

Related U.S. Application Data
(60) Provisional application No. 61/613,611, filed on Mar. 21, 2012.

(51) Int. Cl. H04L 29/08

(52) U.S. Cl. CPC H04L 67/306
USPC 709/204

(57) ABSTRACT

Method, system, and programs for providing content to a user. In one example, the user is associated with a first user group. At least some information of the user corresponds to a first topic associated with the first user group. A second user group is then determined based on the first topic associated with the first user group. A second topic associated with the second user group is different from the first topic associated with the first user group. Content related to the second topic associated with the second user group is provided to the user.

### CROSS-REFERENCE TO RELATED APPLICATIONS

The present application claims priority to U.S. Provisional Patent Application No. 61/613,611, filed on Mar. 21, 2012, entitled “METHOD AND SYSTEM FOR PROVIDING CONTENT TO A USER,” which is incorporated herein by reference in its entirety.

### BACKGROUND

1. Technical Field

The present teaching relates to methods, systems, and programming for Internet services. Particularly, the present teaching relates to methods, systems, and programming for providing content to Internet users.

2. Discussion of Technical Background

While more news is available than ever before, people increasingly are having a difficult time getting news. Most people, almost paradoxically, have two complaints about their news: they don't get enough of it, and they get too much of it. The complaint that they don't get enough of it stems from their feeling that there is news out there that they are missing, and they don't know how to find it. It's a conversation of discovery. The complaint of too much news stems from their challenges in prioritizing what they want to read now, read later, and not read at all.

Additionally, in the industry today, there is a lot of focus on helping people get their news when they are “browsing.” There are myriad tablet and smartphone apps that have rich digital magazine experiences. There isn't nearly as much focus, however, to another mode of news consumption, which we will call “checking” Checking is what one does during a busy work day, where they very quickly need to see what they've missed since the last time they checked, prioritize, and get back to work. They are very much concerned with not missing anything. Yet, there isn't anything on the market that satisfies that need.

Therefore, there is a need to provide an improved solution in order to solve the above-mentioned problems.

### SUMMARY

The present teaching relates to methods, systems, and programming for providing content to a user.

In one example, a method, implemented on at least one machine each of which has at least one processor, storage, and a communication platform connected to a network for providing content to a user, is disclosed. The user is associated with a first user group. At least some information of the user corresponds to a first topic associated with the first user group. A second user group is then determined based on the first topic associated with the first user group. A second topic associated with the second user group is different from the first topic associated with the first user group. Content related to the second topic associated with the second user group is provided to the user.

In another example, a method, implemented on at least one machine each of which has at least one processor, storage, and a communication platform connected to a network for providing content to a user, is disclosed. A plurality of user groups is provided to the user to join. Each of the plurality of user groups is associated with a topic. An input is then received from the user indicating selection of joining a first user group from the plurality of user groups. The first user group is associated with a first topic. A second user group that the user did not select to join is determined. A second topic associated with the second user group is different from the first topic associated with the first user group. Content related to the second topic associated with the second user group is provided to the user.

In still another example, a method, implemented on at least one machine each of which has at least one processor, storage, and a communication platform connected to a network for providing content to a user, is disclosed. The user is associated with a first user group. At least some information of the user corresponds to a first topic associated with the first user group. At least a second user group is then provided to the user to select. A second topic associated with the second user group is different from the first topic associated with the first user group. An input is received from the user indicating selection of the second user group. Content related to the second topic associated with the second user group is provided to the user based on the received input from the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1(a) and 1(b) are high level exemplary system diagrams of a system for providing content, according to an embodiment of the present teaching;

FIG. 2 illustrates the organization of the user interface of the system, according to an embodiment of the present teaching;

FIGS. 3(a) and 3(b) depict an exemplary dashboard unit of the system, according to an embodiment of the present teaching;

FIGS. 4(a) and 4(b) depict an exemplary zoomed unit of the system, according to an embodiment of the present teaching;

FIGS. 5(a) and 5(b) depict an exemplary discover unit of the system, according to an embodiment of the present teaching;

FIGS. 6(a) and 6(b) depict an exemplary explorer unit of the system, according to an embodiment of the present teaching;

FIG. 7 depicts an exemplary profile unit of the system, according to an embodiment of the present teaching;

FIG. 8 depicts an exemplary setup unit of the system, according to an embodiment of the present teaching;

FIG. 9 depicts an exemplary networked environment in which the system is applied, according to an embodiment of the present teaching;

FIG. 10 depicts a general computer architecture on which the present teaching can be implemented;

FIG. 11 illustrates an exemplary argument tree, according to an embodiment of the present teaching;

FIG. 12 is a flowchart of an exemplary process of providing content to a user, according to an embodiment of the present teaching;

FIG. 13 is a flowchart of another exemplary process of providing content to a user, according to an embodiment of the present teaching; and

FIG. 14 is a flowchart of still another exemplary process of providing content to a user, according to an embodiment of the present teaching

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present teaching relates to a method and system that allow a user to discover, receive, organize, and understand content (news) from multiple sources, and do so in a way that is efficient, stimulating, and engaging. The method and system may be implemented as, for example, a website, computer applications, mobile applications, and potentially mobile devices. The method and system help a user not miss anything as they quickly and efficiently discover and prioritize news stories/articles. Additionally, it helps people understand the news they are consuming, so they can be empowered to make a difference in the world, however they want to.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

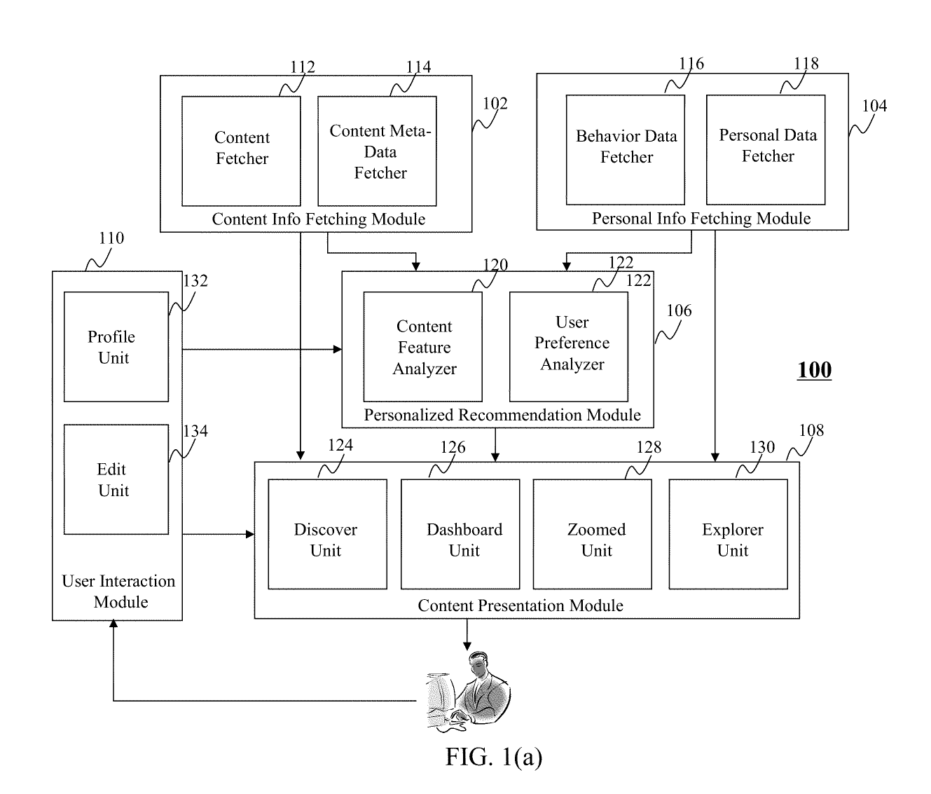

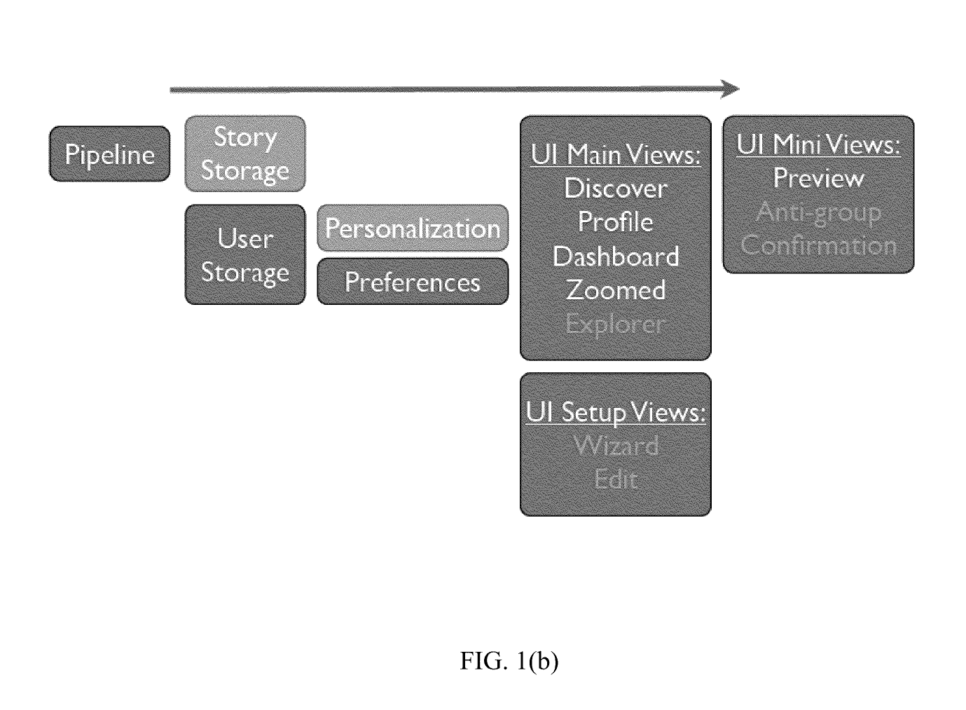

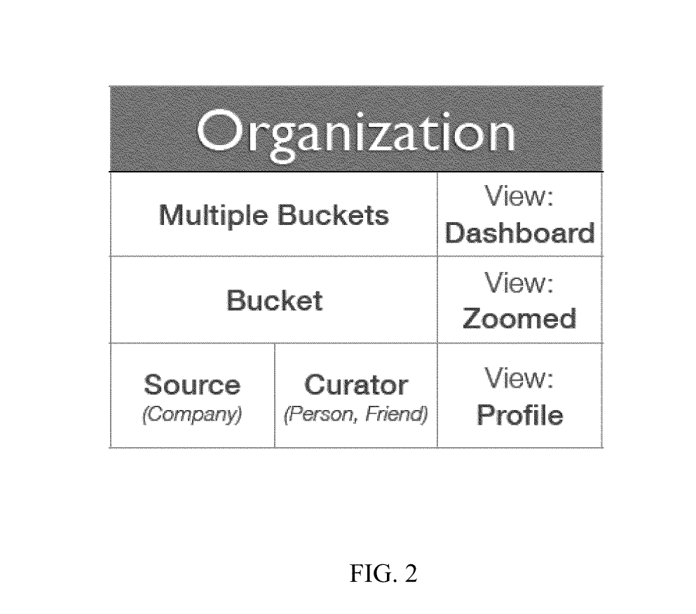

FIGS. 1(a) and 1(b) are high level illustrations of a system for providing content, according to an embodiment of the present teaching. The system 100 may include a content information fetching module 102, a personal information fetching module 104, a personalized recommendation module 106, a content presentation module 108, and a user interaction module 110.

The content information fetching module 102 may include a content fetcher 112 configured to fetch stories from various sources and curators and a content meta-data fetcher 114 responsible for collecting content meta-data that is attributed to the stories. For the purpose of the present teaching, a “story” may be anything the user considers news, and may be transmitted by sharing or publishing a link. It may be a written article, but may be a picture, podcast, video, audio, etc. For example, a story may be published by the owner of a store or if a news outlet writes a story about the store or an update some shares on a social network that “go to this link X to see what I saw at the store.”

While in “browsing” mode, users may consume any multitude of stories on a given topic of their interest. In “checking” mode, however, people don't have the time or curiosity to evaluate every story based solely on its merit—they want to know where the story is from. Because of that, the system 100 helps users follow sources and curators, as opposed to just specify topics. While the distinction between a source and a curator is somewhat academic, a “source” may be an entity that produces news, such as, for example, CNN, The New York Times, etc., which distribute a large volume of stories. On the other hands, “curators” may be individuals, for example, industry experts, editors, and friends, who share stories. Sometimes these individuals may also publish original content—say in their blog. Regardless of what exactly is the difference between a source and a curator, the important value that is created is that the user finds a story more valuable because it is received from something or someone that they know, and that entity has selected those stories to be published, distributed, or shared.

Some publishers, sources, or users may be able to interface with the system 100 to provide customized curators. The system 100 may have usage data (more on that below) which could be used by the system 100 as well as 3rd parties to create custom curators that individuals can sign up for. Additionally, they may be able to create automatic feeds, where a user may automatically share and distribute anything within any of their buckets.

Users may be able to group sources and curators into “buckets.” The stories found in these buckets are much more meaningful than stories simply by topic, because they are only stories from known and valued sources and curators. A user may be able to view or receive all stories from all sources and curators that they follow, individual buckets, and individual sources and curators as they wish.

To receive a story from a source or curator may mean anything from subscribing to an RSS feed, receiving a link shared on Facebook, Twitter, LinkedIn, or any other social network, receiving stories via emailed newsletter through a proxy email account, or any other way news is distributed. Stories may be in the form of text, pictures, video, audio, or any mix of those media. On some social networks and link sharing systems, users may share with a comment. These may be displayed as well.

Various content meta-data may be captured that is attributed to the stories themselves. These may be used for analytical and display purposes described in following sections. The meta-data that is captured includes, but is not limited to:
Recency: Date/time(s) published, shared, and/or modified.
Location(s)(geo-tag): where the story takes place—there may be multiple locations ascribed to a single story.
Popularity: the metrics and behavior around the reading and/or sharing of the story (elaborated more above).
Topics and topic hierarchy.
Keywords.
Source (within or outside the system).
Author.
Preview image.
Preview or description of story.
Argument structure: any one or more of: free-form, [premise(s)→logical process(es)→conclusion(s)], [claim(s), data, warrant(s), backing, rebuttal(s), qualifier(s)]#, or any other argument structures or mixes thereof, including multiple structures simultaneously.
Entire argument structure's validity and/or any of its elements' validity.
The story's use to validate, refute, or some other way to contribute to another story's argument, validity, or topic.

There may be several different methods for capturing these meta-data. The methods include, but are not limited to:
Directly through the platform: a publisher/source may enter the meta-data directly into our system.
A publisher/source may encode the meta-data in the story itself, such as embedded HTML tags.
A publisher/source/link-sharer may include some of the metadata in sharing networks such as twitter, where the system 100 can hash-tag a keyword or topic, as well as geo-tag a location.
A human may directly enter or edit any of these meta-data if they are missing or inaccurate. They may even be prompted if the system 100 detects that it is missing. This may be a regular user, a volunteer who devotes time to up-keeping these meta-data, and/or company and/or source and/or curator personnel.
The platform system may analyze the story, using artificial intelligence/machine learning/natural language processing/or simpler algorithm to discern any of the meta-data that it can.
Combination: the system 100 may use a combination of all of the above to ensure accuracy and timeliness.

The personal information fetching module 104 may include a behavior data fetcher 116 configured to collect users' (or curators or sources') behaviors for the purposes of analytics, personalization, and sharing and a personal data fetcher 118 configured to capture or receive the users' (or curators or sources') existing social networking information.

Various information may be captured by the behavior data fetcher 116 about users' and curators' behavior for the purposes of analytics, personalization, and sharing, such as, but not limited to:
Read: If a story was clicked on to view/listen/consume, as well as how long it took to read, how far down the screen they scrolled while reading an article (they don't need to click on an article to read it if they arrived at the story not from within the system). Any single or combination of these may be used to determine whether or to what extent a story is read.
Shared: if they shared a story. What they shared and when they share it. What their comments were when they shared. (And, subsequently, how often they share or publish).
Argument formation or addition: user/curator/source may create, add, or modify the structure of an argument or arguments of a story.
Argument validation and/or qualification: user's/curator's/source's opinion of the validity/quality of all and/or part of the argument of a story (examples: opinion in binary (e.g., “agree/disagree”), ternary, ranking, point value, category (“true,” “straw man,” “fallacy”) and/or a mix and/or some other evaluator).
Which sources, curators, and buckets they follow/subscribe to, and when.
Who they are friends with or follow on other social networks.

These behavior data may be collected in various ways, such as, but not limited to:
Through a browser, browser plug-in and/or app and/or mobile app: for whether or how much of an article is read, and time to read.
Through the system or another social network (or its API) for sharing.
Through website scraping and capturing (for data collected from other social networks, as an example).
Through the system directly as an action/request to follow/subscribe.

Either discerned through the user's (or curator or source's) existing social network information or directly entered by the user, the personal data may be captured personal data fetcher 118 about the user, such as, but not limited to:
Group membership: political affiliation, religious affiliation, fan groups, professional groups, hobby groups (e.g., guitar players, liberals, bears fans, atheists, marketers, consultants).
Avatar/profile picture.
Demographic data.

These personal data may be collected in various ways, such as, but not limited to:
By direct entry from the user, curator, or source, respectively.
Scraped from a social network profile (e.g., from Facebook's political affiliation profile field, profile picture).
Collected from a social network via its API.
Inferred from other data about the user and similar users using computational statistical methods, machine learning, Bayesian analysis, etc.

The personalized recommendation module 106 of the system 100 may include a content feature analyzer 120 and a personal preference analyzer 122. Based on the above fetched datasets, the personalized recommendation module 106 is configured to make recommendations of stories to read that are most likely to be read. This algorithm may take into account user history and settings as well as potentially any or all users' histories and settings. It may also take into account story recency and popularity (how often read and shared), as well as popularity and publishing/sharing frequency of sources and curators, and/or any data or calculation off of any of the above data sets. The personalized recommendation module 106 may further make recommendations for topics. This may be done directly from the topics of the stories that have been selected or viewed, as well as may use an alternative method for assigning topic: other users' assignment of bucket names that those stories are most likely to appear in or most uniquely appear in.

In addition to topic recommendations, source, curator, bucket, and group recommendations may also be made. All of these may be based on the same recommendation processes as with stories: based on the above fetched datasets. If other users that have a similar history and settings as the user have a given bucket or buckets, that bucket or those buckets may be recommended to the user. Any recommendation may exclude all stories, sources, and curators that the user already receives or follows.

In addition to the above-described methods for discerning topics and related subtopics (a topic hierarchy), user behavioral data on how sources and curators are most often grouped together into buckets can imply a hierarchy. For example, if several sources and curators are most often appear exclusively in a bucket called television, and inclusively with other sources and curators in buckets called “entertainment,” then it can be inferred that the hierarchy of topics is that within the topic of “entertainment” is a subtopic called “television” and stories from those member sources and curators would also be about the topic “television.” This method may be used along with or instead of other methods for fetching behaviors and personal data as described above.

The system 100 may further include the content presentation module 108 for organizing and presenting content to the various user interfaces based on the recommendations of stories, topics, source, curator, buckets, and groups. The content presentation module 108 may include a discover unit 124, a dashboard unit 126, a zoomed unit 128, and an explorer unit 130, each corresponding to one type of user interfaces.

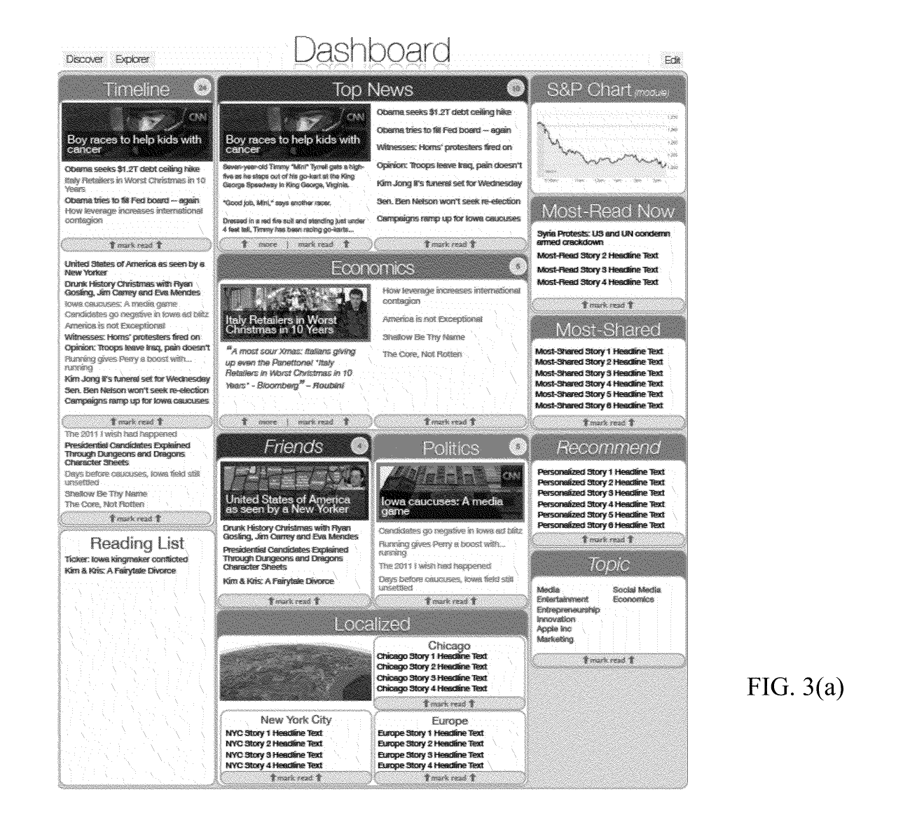

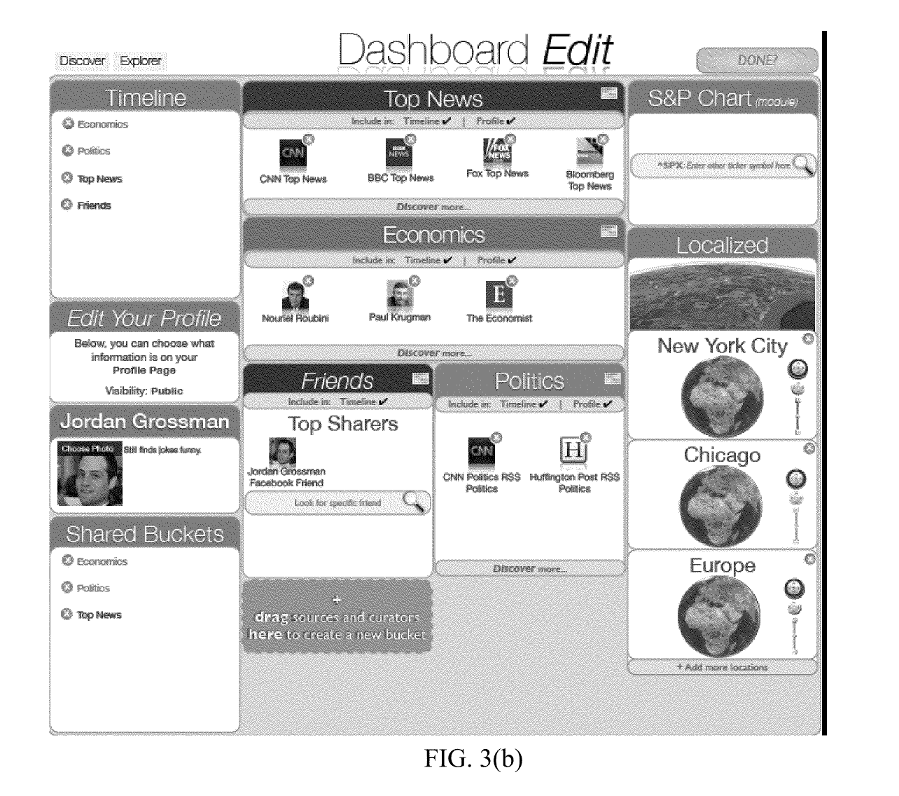

Prioritizing and Selecting News—The Dashboard (dashboard unit 126, FIGS. 3(a) and 3(b))

Buckets and Boxes

On this main page used to view news, the user may see all of their buckets laid out horizontally and vertically on the page. This makes efficient use of the screen real estate so that users can quickly see the maximum amount of stories without needed to scroll. Because they are in buckets that the user has set up, they have the most meaning, and they know where the stories are coming from.

Each bucket may have its own color, either automatically specified randomly by the system, automatically specified based on the most common or likely color based on other users' preferences, or by the user's own choice.

Newest stories may be at the top of any list within a bucket, where the top story in the list may have the story's main picture and title more prominently displayed, as well as an icon or avatar of the source or curator that the user is following. Alternatively to newest story at the top may be most read, most shared, or specifically designated as a “top story” by a source or curator.

The position of the buckets may be manually set by the user, or automatically positioned based on how often they use the bucket. Use may potentially be informed by one or more of the following: frequency of previewing a story, frequency of going to a story, a mix of both, and/or via direct or calculations based on any of the above collected data sets, etc.

The size of the buckets may be manually set and/or potentially informed by the same algorithm and/or data sets used to determine the bucket position.

Examples of an algorithm for bucket size and position include, for example: the top 3 buckets that are most clicked on may be above all other buckets and span two columns. On one side of the bucket is the top story's picture and title, followed by the comment from the curator who shared it. On the other side of the bucket, there may be another story's picture and title at the top, followed by a list of some of the remaining and most recent stories within the bucket. Smaller buckets that are below may be single column-wide buckets with a story picture and title at the top followed by titles of the remaining most recent viewable stories in the bucket.

In one example, only stories that are unread or marked as keep unread may be visible. Any story that has been selected and the preview bubble has displayed the preview may be marked as read once the bubble has been closed, unless the “keep unread” button in the bubble has been hit to designate that it should be kept unread until the user explicitly designates that that it has been read by returning to that bubble and deselecting the selection of “keep unread.”

For consistency and clarification, the nomenclature used here is that a bucket is a collection of sources and curators grouped by or approved by the user. The visual representation of these may be in a box. Other boxes exist in the design that also show stories, topics, a timeline, etc. Visually, a bucket may be a type of box, but a box is not necessarily a bucket.

Timeline

The left side of the screen has a timeline that is the compilation of all stories received from all sources and curators that the user is following, minus those in buckets a user has specified not to be shown on the timeline (this preference is set on the edit screen). Newest stories may be at the top.

Reading List

The bottom of the timeline may be a specially designated area, called the “Reading List” with a line of demarcation that shows where stories below that mark are all stories marked “keep unread” for later reading. Stories above that mark may be newer stories that are a mix of new, unread stories, as well as stories marked “keep unread.” Those stories may eventually be marked as read (by being viewed in the preview bubble) and disappear, or as new stories appear in the timeline, they may be pushed down and eventually be below the line of demarcation for being a “keep unread” story.

Numbers of Unread

At the top of each bucket and the timeline, it may show the number of unread stories in that bucket or the timeline. Because some buckets may not be checked as frequently, and because those buckets may stress many users out, there may be an option to hide the number of unread items in that bucket. This may automatically be hidden when a user selects to hide that bucket from the timeline based on how many unread stories there are, or some behavioral data suggesting that the user may prefer not to see the number of unread.

Mark Above as Read Bar

Because the system is designed to help people decide what they do and don't want to read and see what they haven't read yet, the act of marking something as read so it disappears from the list is very important. There may be bars at the bottom of each bucket or box as well as bars evenly spaced in the longer timeline. These bars, when clicked, may mark everything above it as read, except for stories that the user has marked “keep unread.”

Local News

There may be special boxes that display stories that are in the specified locations of the user's choosing. The display stories may be a subset of unread stories from all of the followed sources and curators of the user as well as other stories geo-tagged within a preset geography of the user's specification. The user may add multiple locations. Each location may be set in the Edit view, and the geography specified by rotating and zooming a map—all stories tagged within that view may be displayed in that location. Each location may have its own subsection in the locations bucket.

There may also be a map at the top of the bucket that plots several of the locations and the stories within those locations as dots on the map. In one example, this map may only display the locations that are close enough to each other to fit onto a single map view.

For each location, or for some locations, there may be weather information from that location automatically placed there.

By the user specifying what locations to get news, in addition potentially to weather information, there may be local deals or advertising served.

Misc Right Column

Potentially, on the right side of the view, there may be several more boxes. The top may be the customizable stock chart. There may be also a box listing most read stories system-wide (ranked in deceasing readership amount), as well as a similar box for shared stories. The summary time frame for declaring “most read” or “most shared” may be set to anything from a minute to a year. There may be multiple boxes with different time frames (e.g., one called “Trending”).

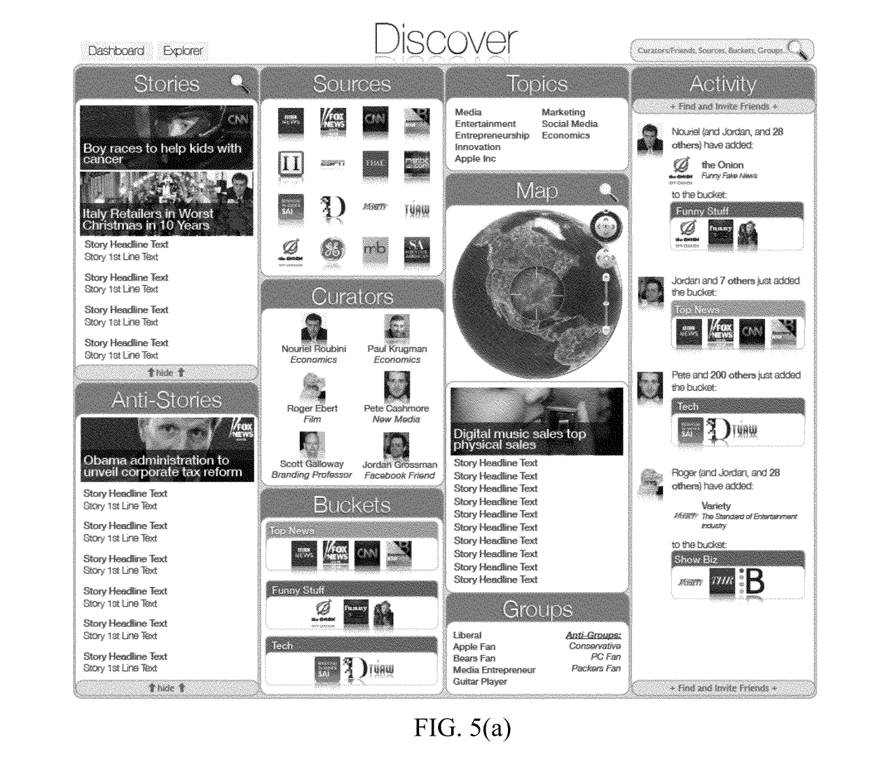

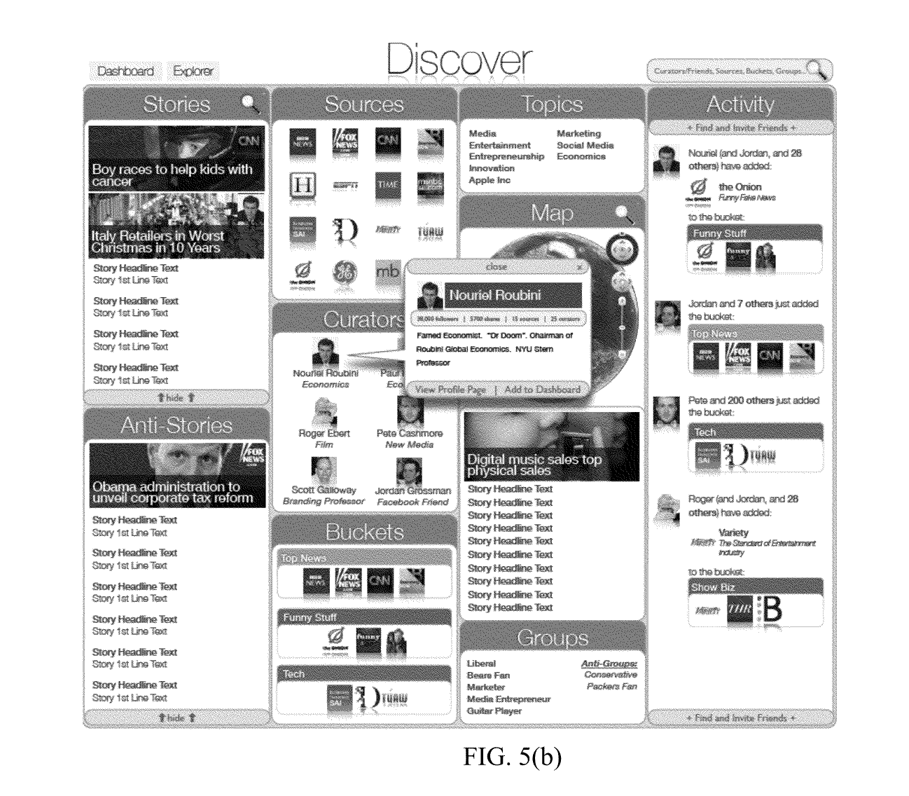

The final two buckets include personalization boxes, recommending stories and topics, respectively, based on the aforementioned methods of personalization. Clicking on a topic may bring the user to the discover screen with a search applied for that topic. The default states of the recommended stories and topics may have the same settings and draw from the same lists, displayed to the extent space may allow, as the stories and topics boxes of the Discover page. Underlying functionality is explained more with respect to the discover unit 124 in FIGS. 5(a) and 5(b). The main difference in functionality of the topics box in the dashboard is that clicking on a topic may take the user to the Discover view, where the view may at that point behave and respond in the same way as though the same topic was just chosen from within the Discover view itself. Further details are in the Discover section.

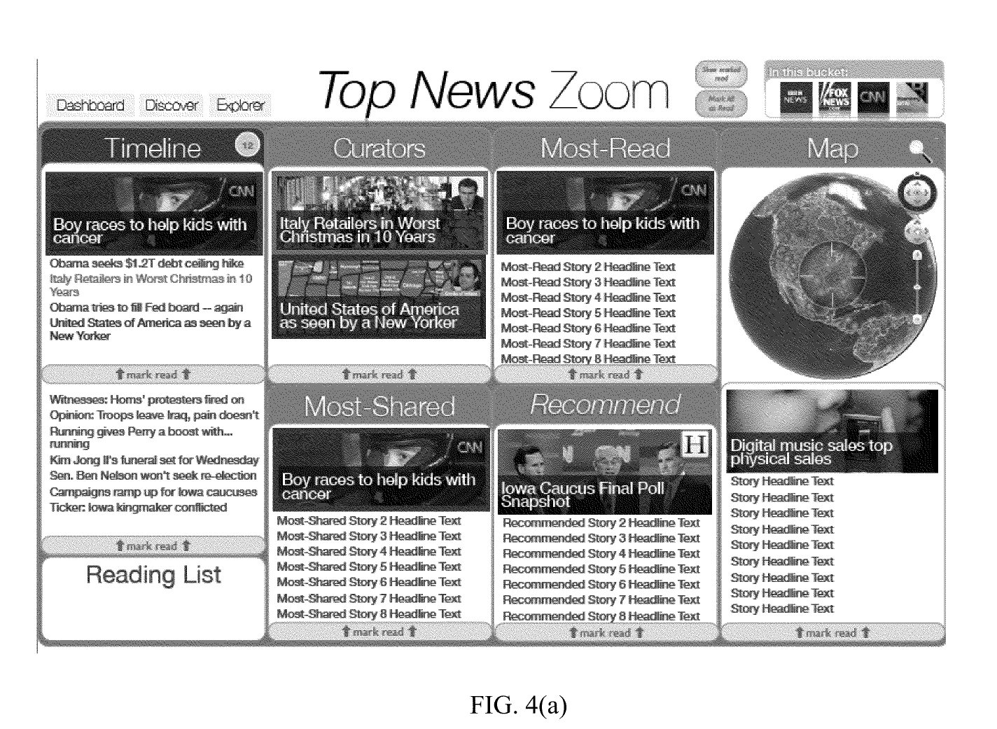

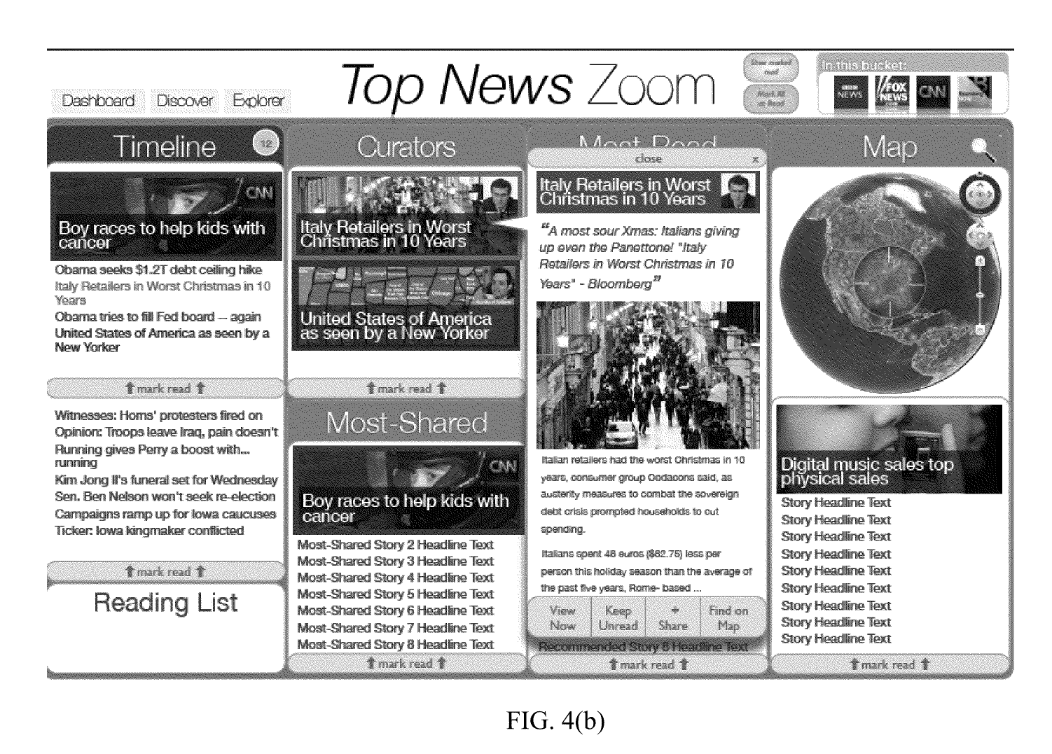

What's Inside a Bucket—Zoomed Bucket View (Zoomed Unit 128, FIGS. 4(a) and 4(b))

A user may click on a bucket/bucket title in the dashboard and “zoom in” to it, where it may see the Zoomed view. The purpose of the zoomed view is to give a full screen to the contents of the bucket, so they can see more stories to read, save for later (mark unread), or mark as read to be hidden. Additionally, it helps the user see what's most important, based on a few different parameters, separately: has a curator shared a story, what's most read, what's more shared, what's near them or another geography they care about, etc. Additionally, it helps the users see if there are other similar stories from sources and curators they do not currently follow (recommendations). The Zoomed Bucket view will also serve as a preview of a bucket if a bucket they do not follow (e.g., one found on the Discover View) is clicked on.

Timeline

There may be a timeline that functions the same as on the dashboard, with the differences being: the stories that may appear are from the sources and curators that comprise that bucket; there may be an option to mark all stories that comprise the bucket as read (except stories that have been marked “keep unread”); and there may be an option to view stories that have been marked read—a temporary remediation if a story is accidentally marked as read and has subsequently disappeared from view.

Curator Recommendations

If a story in the bucket's timeline box has also been shared by any followed curator (including friends on social networks), it may appear in this bucket.

Most Read

Stories in the timeline may be sorted by what is most-read. The timeframe for this ranking may be anything from the past minute to a year or more. Additionally, it might be automatically chosen based on how old the oldest story in the timeline is (e.g., if someone hasn't cleared out/marked read stories in that bucket for 3 weeks, it may list the top-read stories over the past 3 weeks, or some approximation of that).

Most Shared

Same as Most Read, except for sharing incidence.

Recommended

The system may recommend stories that the user does not currently subscribe to that are of the similar/same topic as the bucket the user has zoomed into. As elaborated above, there may be multiple methods for doing this: one example would be to determine by common association of the sources and curators in the bucket, what other sources and curators that group is most commonly associated. Those additional sources' and curators' stories may appear in the recommended box, and sorted by how new they are, how much they have been read, how likely they are to be read by the user, or some combination of all of those.

Mapped News

The contents of the bucket's timeline box, as well as potentially the recommended stories box, may be plotted onto a map. Potentially with the map, stories may be sorted by how close they are (based on their closest geo-tag) to the center-point of the map view. A user may change the latitude and longitude of the center-point by dragging the map, and may also zoom in and zoom out of the map view. A change in the center-point may optionally trigger a re-sorting of the list below the map. The default center-point of the map may be the user's current location. A user may also click on the map and it will re-center to the point clicked (they could click on a dot representing a plotted story, or just the map's geography itself).

Previewing News—The Preview Bubble

Any displayed story may be clicked on/selected. This may bring up the Preview Bubble. The preview bubble may have a preview and information about the story, as well as options for further action.

Story Preview Elements

Elements of the story may be presented to the user include, but are not limited to: title, followed source or curator that shared the story (via avatar), preview picture, preview text or description, curator's comments related to the story, curator's use of the story (as part of an argument tree, if applicable), etc.

User Actions

A user may hit any of the following button to cause their following respective actions:
Close: the preview window may close and the story may be marked as read, unless it has been marked “keep unread” already, in which case the window may just close.
View story: may display the story at the original source.
Keep unread: Clicking this may cause the story to be treated as though it has never been read.

This treatment may remain until the user returns to its preview bubble and de-selects this option. Attempting to mark this story as read by any other means may be ignored (e.g., if the user hits a mark read bar).
Share story: the story may be shared on social networks of their choosing, over email, and on this system for anyone to see (with privacy exceptions).
View on map: selecting this option may take the user to the zoomed bucket page it is found in, or stay on the zoomed bucket page if the user is already there. If the user is on the Discover page, the user may stay there. When the user has been directed to the appropriate page, or if the user is on the appropriate page (Zoomed Bucket or Discover), the center-point of the map may be set to the (first/main or average/mean) center location of the story and, subsequently, a ranked list may have the story at the top of its list.

Discovering News—the Discover View (Discover Unit 124, FIGS. 5(a) and 5(b))

When a user wants to see what they're “missing.” they may go to the Discover view. The purpose of the Discover view is to help users discover new stories, sources, curators, and buckets. This may be done by personalization, selections of topics or groups of interest, and based on users learning from what their friends and other followed curators do.

Stories, Sources, Curators, and Buckets Boxes

At the heart of what is to be discovered—stories, sources, curators, and buckets are prominently displayed (“the four boxes”). What drive the display is personalized recommendations by default (described above). The stories may be ordered by most recently published first, and/or singularly or in combination with most likely for the user to click or view. Most likely to click on or view is how the sources, curators, and buckets would be ordered.

This collection may be further updated based on topics, groups, or anti-groups that may be selected (elaborated below).

The time frame of the ranking of stories may be last minute to last year or beyond. If it's a shorter timeframe, it may be for “trending stories” that have seen a spike in viewership in the most recent minute. A year's time frame may show the most-read story over the course of the past year. The time frame may be either user-optional or there may be multiple boxes each having different time frames and weightings of other selections and sorting parameters.

Topics

The personalization process may also produce recommended topics, as described above, and when a topic is selected, the set of personalized or recommended news may be filtered and updated to reflect that selection. Furthermore, when a user selects a topic, in addition to updating the displayed stories, sources, curators, and buckets lists, it may also display subtopics of the selected topic. This hierarchy may have multiple levels. As an example, if the topic of “entertainment” is selected, subtopics may, perhaps, be “new media” and “traditional media.” Within traditional media, there may be subtopics of “movies, radio, music, TV, theatre.” The methods to define the topic hierarchy are mentioned above.

Map

The map may function same as in the Zoomed Dashboard view, plotting and sorting stories that are displayed in the stories box.

Groups

Groups that a user is a member of may be displayed. Clicking on a group may refresh the stories, sources, curators, and buckets to for members of that selected group. Refreshing for the group means that the system may select those elements that most typify the group membership: they are most read, most likely to be clicked, read, or followed for members of the group, but less likely for non-members. This may be done using computational statistics, Bayesian analytics, and/or other common techniques to the field.

Anti-Groups/Curiosity Groups

Some groups have naturally opposite groups (“Anti-Groups”) as a subset of other groups they are not members of, but are curious about. If a group is “Liberal,” an opposite group may be “Conservative.” A user may specify what the anti-group is for any of the groups they are a member of The system may store and reapply that relationship for another user who has the same group membership (e.g., if a user says the opposite of a Bears fan is a Packers fan, other Bears Fans may also have an anti-group of Packers Fans). In some examples, the system may determine the anti-groups or curiosity groups by checking the topic of the user group against a knowledge archive, e.g., encyclopedia, Wikipedia, or a dictionary. For example, if a group has a topic of “Pro-Life,” the system may automatically check the term “Pro-Life” against, e.g., Wikipedia or any other knowledge achieve, to find that its opposite topic is “Pro-Choice” and link the two groups (“Pro-Choice” and “Pro-Life”) as anti-groups. It is understood that the relationships are not limited to being opposite and may be, for example, being categorically distinct or different (e.g., Bears Fans vs. Packers Fans). The relationship may be as a possible recommendation, where an individual user may over-ride or void whatever an anti-group is for any of their groups. Some groups may not have anti-groups, so the field may be blank and return nothing, or the user is uninterested in them, so then the system will not return an anti/curiosity group. For whatever groups the user is a member of that have anti-groups, those anti-groups may be listed. Clicking on them may provide the same functionality as clicking on any other group—refreshing the stories, sources, curators, and buckets just as though the user is a member of that group (instead of its opposite).

Anti-Stories

While a user can click on a specific anti-group and have the four boxes be refreshed, this box may already display the most recent or most likely to read stories from all of the user's anti-groups. It may draw from the set of stories created by individually selecting each anti-group and ranks them together, by published time and/or popularity (clicked, read, and/or shared).

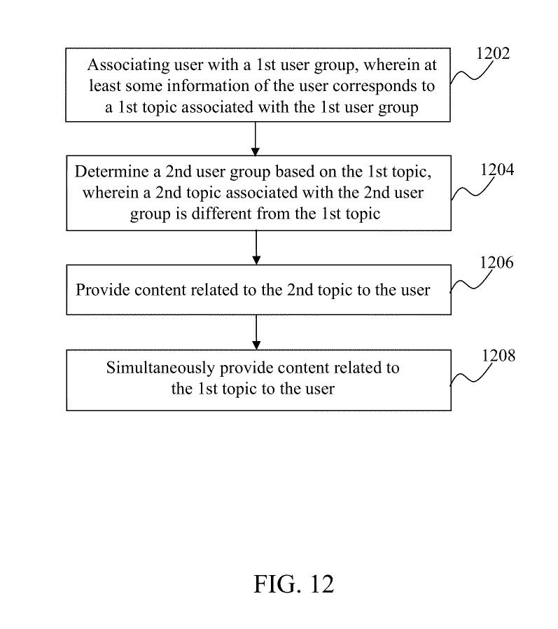

FIG. 12 is a flowchart of an exemplary process of providing content to a user, according to an embodiment of the present teaching. Starting from 1202, a user is associated with a first user group. At least some information of the user corresponds to a first topic associated with the first user group. That is, the system may decide, based on user information, that the user is a member of a certain user group using computational statistics, Bayesian analytics, and/or other common techniques as known in the art. For example, the decision may be made based on demographics (e.g., age, sex, occupation, residence, etc), history of user online activities, and/or declared or inferred user interests. The user information may match or related to the topic of the user group. At 1204, a second user group is determined based on the first topic associated with the first user group. A second topic associated with the second user group is different from the first topic associated with the first user group. For example, the second user group may be any groups the user is not a member of, but is curious about, such as the “anti-groups” as mentioned above. In one example, if the first topic of the first user group is “Liberal,” then the second topic of the second user group may be “Conservative.” Moving to 1206, content, e.g., news, related to the second topic associated with the second user group is provided to the user. Optionally, at 1208, content, e.g., news, related to the first topic associated with the user may be simultaneously provided to the user as well.

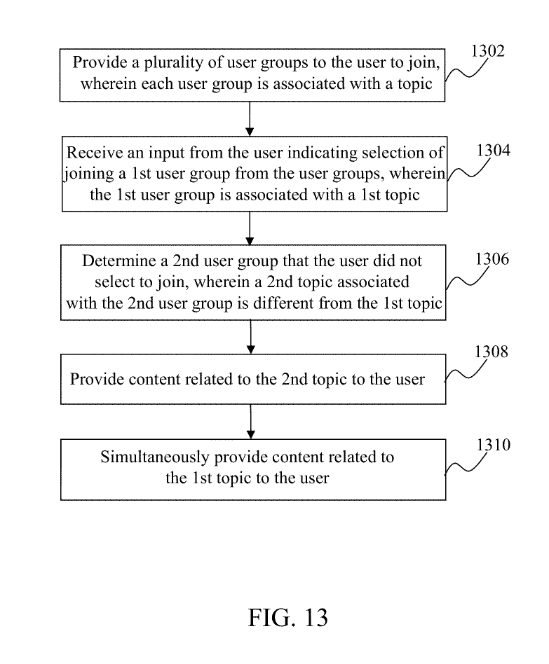

FIG. 13 is a flowchart of another exemplary process of providing content to a user, according to an embodiment of the present teaching. Starting from 1302, a plurality of user groups are provided to the user to join. Each user group is associated with a topic. Different from the embodiment in FIG. 12 where the system automatically decides a user group for the user, in this embodiment, the user is provided with options as to which one or more user groups she/he wants to join. Moving to 1304, an input from the user is received indicating selection of joining a first user group from the provided user groups. The first user group is associated with a first topic. For example, the user may choose be become a member of a user group having a topic of “Liberal.” At 1306, a second user group is determined based on the first topic associated with the first user group. A second topic associated with the second user group is different from the first topic associated with the first user group. For example, the second user group may be any groups the user is not a member of, but is curious about, such as the “anti-groups” as mentioned above. For example, if the first topic of the first user group is “Liberal,” then the second topic of the second user group may be “Conservative.” Moving to 1308, content, e.g., news, related to the second topic associated with the second user group is provided to the user. Optionally, at 1310, content, e.g., news, related to the first topic associated with the user may be simultaneously provided to the user as well.

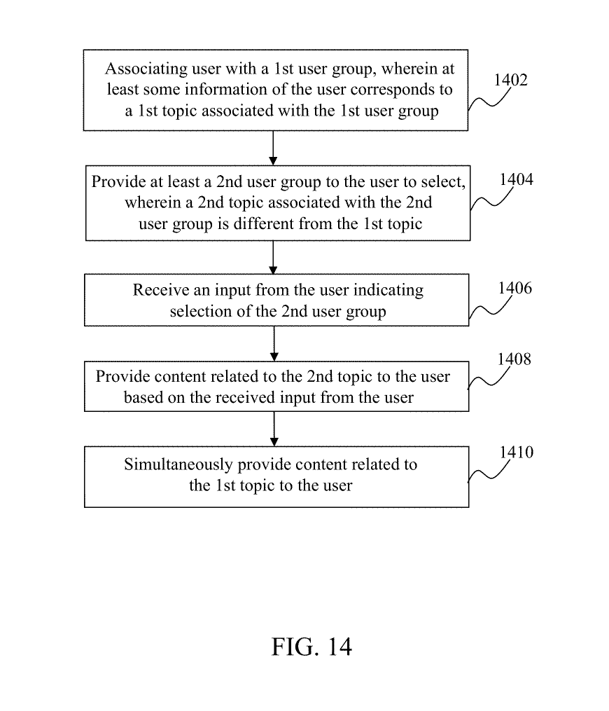

FIG. 14 is a flowchart of still another exemplary process of providing content to a user, according to an embodiment of the present teaching. Starting from 1402, a user is associated with a first user group. At least some information of the user corresponds to a first topic associated with the first user group. That is, the system may decide, based on user information, that the user is a member of a certain user group using computational statistics, Bayesian analytics, and/or other common techniques as known in the art. For example, the decision may be made based on demographics (e.g., age, sex, occupation, residence, etc), history of user online activities, and/or declared or inferred user interests. The user information may match or related to the topic of the user group. Moving to 1404, at least a second user group is provided to the user to select. A second topic associated with the second user group is different from the first topic associated with the first user group. Different from the embodiment in FIGS. 12-13 where the second user group is automatically determined by the system, in this embodiment, the user is provided with options as to which one or more anti-groups or curiosity groups she/he may be curious about even though she/he does not want to join them as a member. Moving to 1406, an input from the user is received indicating selection of the second user group. For example, the user may select one or more anti-groups or curiosity groups. In some examples, the user may not choose any of the anti-groups or curiosity groups. Moving to 1408, content, e.g., news, related to the second topic associated with the second user group is provided to the user based on the user's selection at 1406. Optionally, at 1410, content, e.g., news, related to the first topic associated with the user may be simultaneously provided to the user as well.

Activity Feed

On the right side of the Discover view may be a feed that mentions activity that friends and followed curators have, specifically displaying, chronologically, when a followed curator creates a bucket of followed sources and/or curators or adds a source or curator to one of their existing buckets, as well as participation in argument trees (potentially including validation voting, etc.). This allows users to learn and discover other ways to get and organize news. The user may be able to see the chosen name and color of the curator's bucket, all of the sources and curators within that bucket, and what source or curator is new addition to that bucket, as well as how many other followed curators also follow that newly added source or curator.

There may also be an avatar/profile picture, title, and profile summary of the newly added source or curator.

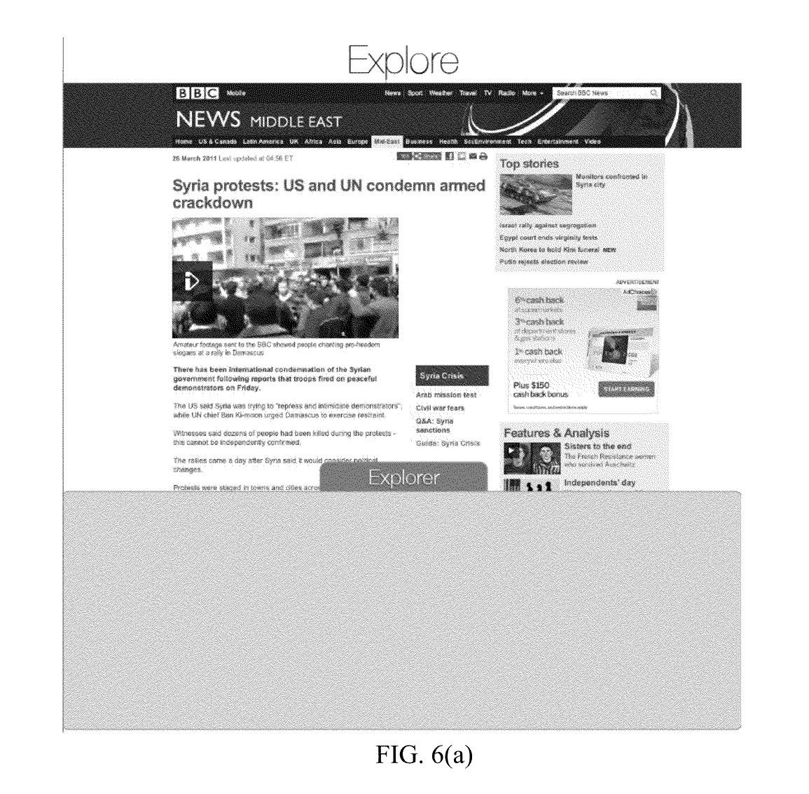

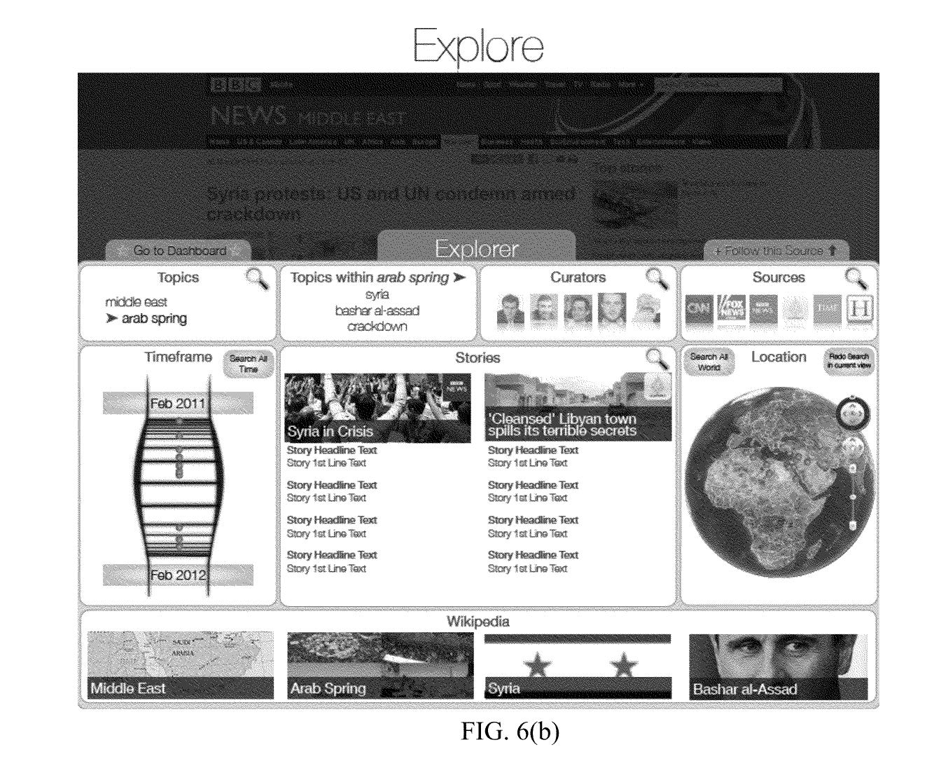

Understand News—the Explorer View (Explorer Unit 130, FIGS. 6(a) and 6(b))

While a user is viewing a story's page, they may desire to understand the story more, the back-story, and in general, the “who, what, where, when, why, and how.” The Explorer is designed to help with that. It may also help a user better understand the arguments that drive the issue, the validity, and related stories, sources, and curators on those issues.

When a user is on a story's page or view (viewed story), they can invoke the Explorer as button, browser plug-in, frame, launch of an application, or pull up another page or view with the Explorer on it. It may be viewed as over, on top of, or in front of the story's page or view.

Who, What, where, when, why, and how—the Search

Search by Topic

The system may display a choice of potential topics and subtopics for the story. It may automatically select topics or subtopics deemed most relevant and helpful to a system-wide search of other stories. Most relevant may include, but are not limited to: confidence of topical match, number of stories available that would match that search criterion, number of popular (read, shared) stories available, position in a topic hierarchy that doesn't yield too specific or general results.

Based on the chosen or default topic of search (including no topic at all), the system may display stories that match that topic or set of topics. The user may also enter any topic of their choosing. The search results may be selected based on at least any one or more of the following: goodness of match to the search topic(s), popularity (read, shared) of the stories, popularity of their sources and curators, other metrics related to the behavior of the source or curator (frequency of publishing or sharing), story recency, etc. The results may be sorted based on at least any one or more of the following criteria: popularity (read/shared), source or curator popularity (aggregate read and/or shared stories, number of followers), story location relative to the Viewed Story location, votes of validity of story or its source or curators, and/or other collected or calculated data aforementioned.

The results may also be filtered based on source, curator, argument, and/or argument validity. Lists of sources and curators may be presented based on at least any one or more of the following: popularity of source/curator, popularity of source/curator stories within results, validity of source/curator, recency/frequency of publishing or sharing of source/curator, and/or any other aforementioned collected data.

In some cases, there may be popular topics of argument, contention, or discussion that the system can also search for relevant stories of similar or same argument or discussion, either as having the same argument or being related to the argument tree defined below.

One or more of the filter elements may be selected simultaneously.

Time-Frame Filter

The user may specify a time frame beginning and end date to filter the search results. By default, there is no time-frame limiting the search, but when the user specifies a beginning and/or an end point, stories may be selected that not only fall within that time frame, but potentially also are chosen to create an approximately even distribution of stories across the time frame. So, as an example, if the time frame is January 1st to December 31st in 2009, and if there are 1000 published stories returned for January 2009, and one for each remaining month of 2009, if the display is limited to 12 stories, it may return one for each month, potentially selecting the January article that is most popular (and/or any of the other aforementioned criteria).

Geographic Filter

The user may also specify a geographic frame within which to search. This may be specified through a globe or map display that may plot returned stories onto the map, allowing the user to spin the globe around/slide the map around as well as zoom in or out. In addition to using the map functionality to see where returned stories are located (and clicking on the dots representing those stories on the map having the same functionality as clicking on the story in the main results box), the view can also be used to filter and re-initiate the search.

The user controlling the center point and zoom of the map may set the geographic frame of the search filter as whatever is viewable on the map. They can then select to have the search be re-initiated based on the current view.

Additionally, the user can deactivate the map's search feature temporarily by clicking “view whole globe,” so they may view any returned articles regardless of location.

In the same way as the time-frame filter optimizes the returned stories to have a more even temporal distribution, the geographic filter/map may return stories that are similarly optimized across the geographic frame.

Argument Trees

One of the central points of frustration and drama of some stories is whether or not they have valid points and understanding the points that drive and determine its validity, as well as the subsequent validity of those points.

Many stories and the arguments, points, conjectures, etc., within the stories (collectively: arguments) may be graphically clarified and made explicit. Also and along with, users, curators, sources, and publishers of the stories may be able to participate in these arguments by supporting, refuting, contributing, or furthering one or more points or comments. In some cases, being able to attach backup evidence helps solve these points of contention, as well as help users understand the issues more and the strengths of the arguments.

Some arguments can have a faulty premise, others a faulty logical process, and others simply a faulty conclusion. In fact, different arguments have different “anatomies” that could be broken down, mapped out, and have different elements evaluated separately. This may help them understand and learn from the anatomies, argue on the anatomies and the validity of each point, and contribute/discover other stories that further the conversation.

This view, either implemented as part of the Explorer, or perhaps separate, may let users, curators, and sources create edit, comment on, and evaluate argument trees. They may be able to highlight text in an article to tag it, comment on it, and share a link to another story that furthers their position.

It may be a requirement that in order to comment on an argument, a unique story needs to be shared. Anyone or only selected people may be able to “like,” rating, vote as “helpful,” or otherwise respond to the argument or its points.

The argument trees may be displayed graphically, where each branch in a tree may originate from a different point and one story can have several trees. Additionally, several stories may be associated to a common argument.

Not all shared stories and comments need to be displayed equally. It could be prioritized where the users, curators, and/or sources that comment based on any or a combination of the following: historic validity of their comments, historic validity of their shared or published stories, votes/likes/rating/marks of “helpful” of the comment, votes/likes/rating/marks of “helpful for the commenting user/curator/source's historic comments and stories, how many users follow a commenting curator or source, and other aforementioned collected data and calculates from those data.

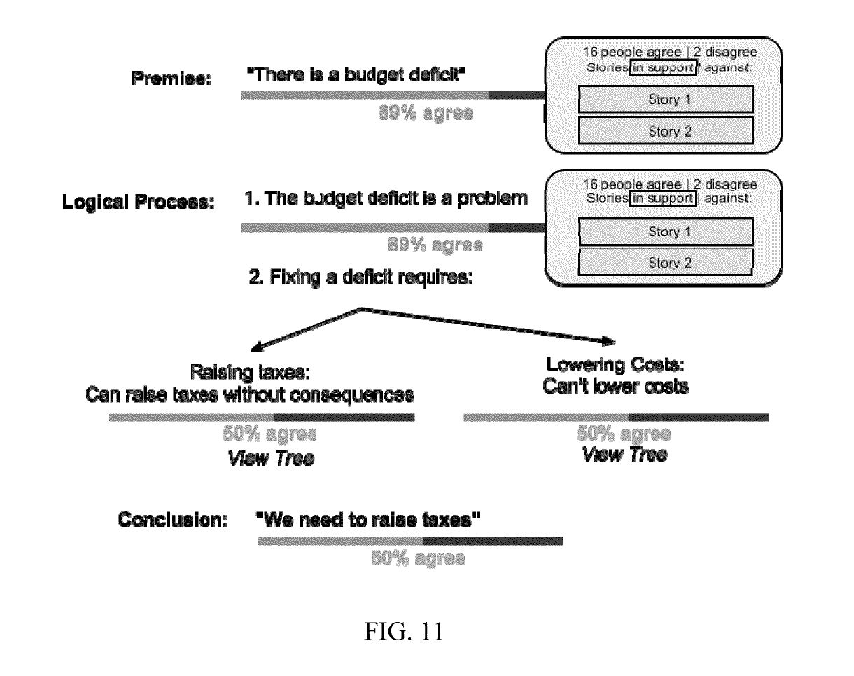

FIG. 11 depicts an example of users or a publisher creating and collectively adding to a tree diagramming an argument to raise taxes. This may have happened as part of or in response to one or more stories that are arguing to raise taxes, and the publisher may have diagrammed it to allow users to quickly see and understand the issues, and/or users/readers may have in part or in whole created the tree to diagram the argument for educational or clarity purposes, as well as to evaluate and respond to/argue with the argument as it has been posed.

While in its simplest form, the entire tree could have been “We need to raise taxes” and it could have been evaluated by users based on that with thumbs up and down. In this example, the publisher or users have opted to create a more detailed tree so each step in the argument may be evaluated separately, starting with the premise that there is a budget deficit. In this example, that may not be a particularly divisive issue. What is clear from this tree is that what is divisive is what to do about the deficit. Multiple options have been outlined—raise taxes and/or lower spending. Each option may be evaluated by users.

Since it may be a requirement that for a user to evaluate any branch of the tree, they may contribute evidence in support of their position in the form of a link to another story/article, there may be an associated story or bibliography to their vote of “agree” or “disagree”. There may even be other ways to vote than just agree/disagree.

Given the premise and the logical process, it's easy to see that there isn't much agreement about the best way to deal with the budget deficit, however a user may clearly see what the issues are, where there is disagreement, and what stories they can read to understand the different points of view.

The users and publisher may take part or all of this tree and embed it into their websites or share it any other way in support of their point of view or overall education. They may associate this tree with other stories if they like—perhaps because those stories have similar arguments. They may also search for these arguments on the system. Stories that appear on the system that are used in an argument tree may be marked as such and provide a view or link to the argument tree and other related stories and responses/points of view.

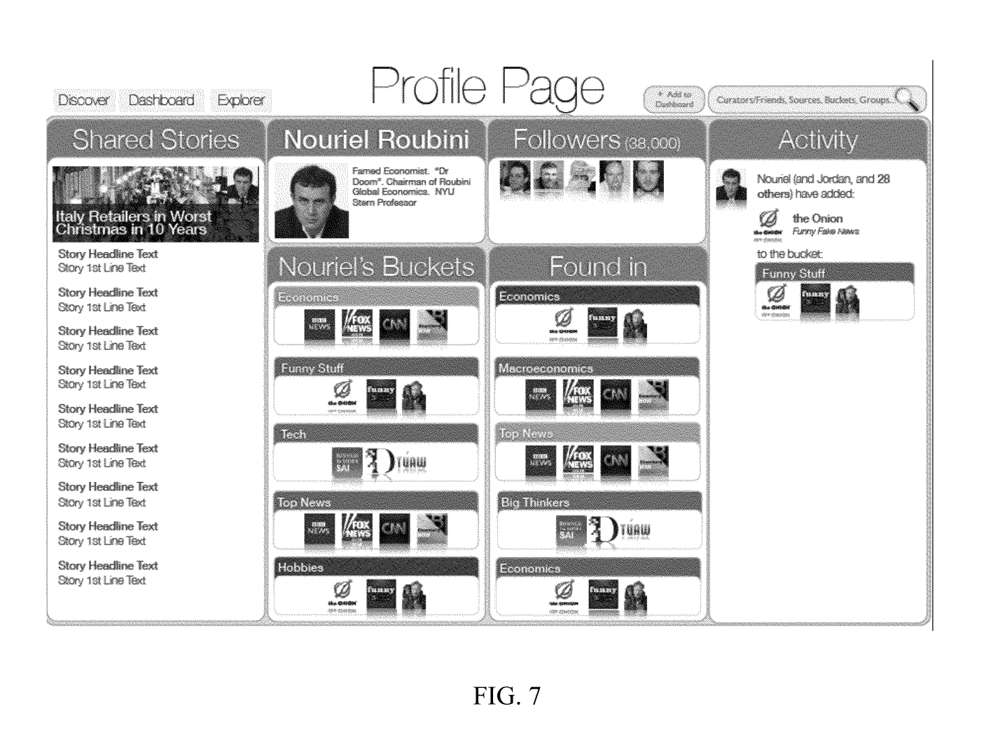

Followed Sources and Curators—their Profile Pages (Profile Unit 132, FIG. 7)

A user (including sources and curators) may claim or create their profile (“profiled user”). This information may be visible on their own profile page for other users (viewing users) to potentially see.

Some of the information that could be displayed for a viewing user to see about another, profiled user include but are not limited to:
Stories: a timeline of the stories that the profiled user has shared/published.
Profile picture: profiled user's avatar.
User description/profile summary: some text about the profiled user. Acquired per the aforementioned methods.
Followers: other users who are following the profiled user, potentially starting the list with people who the viewing user follow, and a running total of users who follow the profiled user.
Buckets followed: shows the buckets that the profiled user follows, capturing where they get their news and how they organize their news.
Buckets found in: shows what buckets the profiled users are most commonly found in on other users' dashboards to see how they are usually classified and categorized.
Activity feed: Same as the Discover View's activity feed, but filtered to include only the profiled user's activity.
Arguments: Capturing arguments that the profiled user participates in, potentially including argument trees and validity rankings, potentially including an associated overall validity ranking for stories and/or arguments that the profiled user has shared as well as metrics that describe how commonly the profiled user has participated in arguments. This may optionally include stories that the profiled user has shared exclusively or inclusively of other stories other users have shared within arguments.

Subscription service: Some sources may have pay-walls for exclusive content. A user may be able to subscribe to a paid content source, possibly with the click of a button from their profile page. As part of this, account messages and management for that source may be found there for that user.

Profile Preview Bubble

When a user clicks on a source or curator (usually on its avatar), they may be taken to a preview bubble made for sources and curators. It may include but is not limited to the following:
Profile information: potentially including Name, Profile Picture, Profile Summary, number of followers, number of sources and curators the profiled source or curator is following, the number of buckets the profiled source or curator is following.
Action buttons: View profile link to take the user to the profiled source or curator's Profile Page. Also a button to add the source or curator directly to the user's dashboard. Clicking on this button will then take the user to their edit page to specify placement of the new source or curator.

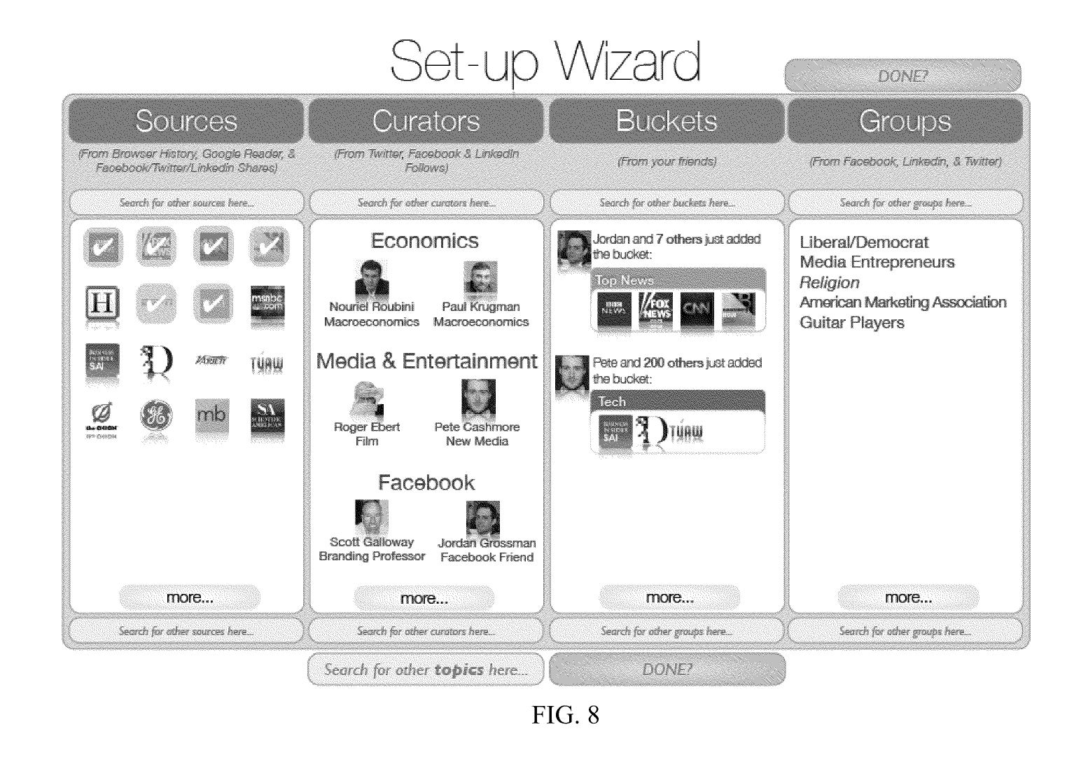

Setting Up User's Experience—the Edit View (Edit Unit 134, FIG. 8)

In order for the user to make changes easily to their preferences and settings in the system, a separate view or potentially views may be used, that could be described in the following:

The layout may be reasonably similar to the dashboard, where helpful, so that a viewer can quickly orient themselves to see where each bucket is.

A user may wish to specify the color of a bucket, or it may be automatically assigned. Bucket names may be managed similarly as color.

They may also drag a source or curator from one bucket to another, or to a space where a new bucket will be created with that source or curator. They may also stop following a source or curator by clicking on an “x” in the corner of the avatar of the source or curator.

A user may have certain buckets that they may not check very often, or only read infrequently. Because of that, they may wish to have those stories not appear in the main timeline. There may be an option to remove or add a bucket to the timeline. Upon removing a bucket from the timeline, the system may automatically hide the number of unread stories in that bucket when in the dashboard and zoomed views. It may also be a separate selection for the user.

The user may modify other settings on what is viewed on the dashboard, potentially including localized news locations, stocks to follow, weather, etc.

The user may also specify what is visible on their profile, including avatar, profile information, privacy settings, and what buckets are visible to other users.

Platform Integration

The system may function as a platform for communicating, sharing, publishing, engaging, and enjoying news. Publishers (sources) may be able to publish directly into the system. In addition, they may be able to access data from the system for stories that they publish, potentially via API.

Publishers may also be able to embed specialized views generated by the system. An example of that may be that, in the process of publishing a story, they may create an argument tree in the system and embed an interactive view of the tree, generated by the system as though the visitor to that site were a user of the system.

Publishers may also be able to manage a paywall/subscription system via the system.

Additionally, as said above, a publisher may be able to add code to published stories so the system may read the code and see the publisher's specification for various collected data mentioned above.

A source or curator may also select or designate stories as priority stories, where the system may “feature” the story by potentially displaying the picture, title, and comment or story preview. This may happen by direct selection in the system, by code in the story's page, or some other method.

Automated Curator

The system may also publish “automated curators” that look and behave like any of the above mentioned curators, however they are actually personalized recommendation feeds that are unique to the user. It may function similarly to how any and all of the aforementioned instances of story recommendation occurs. Additionally, it may make recommendations from a bucket or buckets of the user's choosing.

Automated curators may also be sponsored by source and curators, such as a “CNN Virtual Editor.”

Sources and curators may also be able to use the system's API to access various user specific or generalized data from the aforementioned complete dataset including but not limited to calculations off of that dataset. They may even be able to upload, share, or integrate their own algorithms to the system, so the system may choose and make recommendations on stories for individual users by whatever manner the source or curator would like, potentially without compromising a user's privacy.

Sharing and Recommending of Buckets and Dashboards

A user may share a bucket with another user or any other individual, either within the system or on any other social network or other means. They may also share their whole dashboard or non-private elements of their dashboard (some buckets and source may be marked as private).

In addition to a user sharing, a user may have buckets and whole dashboard(s) recommended to them by the system using known techniques such as, predictive, analytic, Bayesian, or recommendation techniques that are previously discussed, although with potentially presenting these recommendations along with mention of the user, and/or their friend who has those buckets in their dashboard (or their entire non-private dashboard).

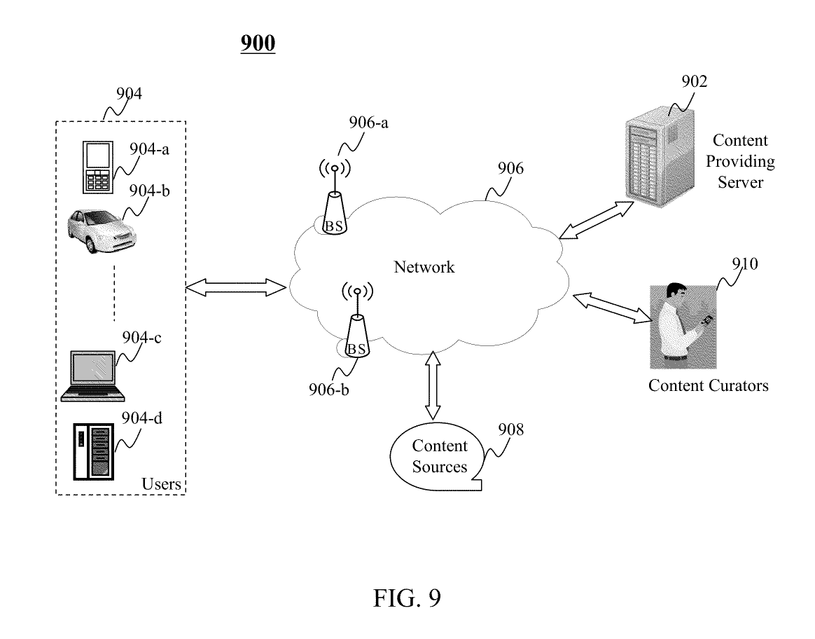

FIG. 9 depicts high level exemplary system configuration in which content providing is performed, according to an embodiment of the present teaching. In FIG. 9, the exemplary system 900 includes a content providing server 902, users 904, a network 906, content sources 908, and content curators 910. The network 906 may be a single network or a combination of different networks. For example, the network 906 may be a local area network (LAN), a wide area network (WAN), a public network, a private network, a proprietary network, a Public Telephone Switched Network (PSTN), the Internet, a wireless network, a virtual network, or any combination thereof. The network 906 may also include various network access points, e.g., wired or wireless access points such as base stations or Internet exchange points 906-a, . . . , 906-b, through which a data source may connect to the network in order to transmit information via the network.

Users 904 may be of different types such as users connected to the network 906 via desktop connections (904-d), users connecting to the network 906 via wireless connections such as through a laptop (904-c), a handheld device (904-a), or a built-in device in a motor vehicle (904-b). A user 904 may have a client-side device that performs the functions of the modules in the system 100 in conjunction with the content providing server 902. In one example, the data personal data collection may be perfumed by the client-side device, or by the content providing server 902 (not exclusively) so that data such and number of reads, may be communicated to other clients. In another example, as to personalized recommendation, there may be user types or segments assigned to the user that could allow the act of personalization to an extent by knowing which articles work for which user types. For example, the content providing server 902 may identify that the user was type “32” (out of maybe 300 groups for example), and some random source that the content providing server 902 instructs the client-side machine is good for type 32 users, then the client-side machine may make selections based on that and download the stories on its side. For certain steps, it may be necessary aggregate data analysis across all users 904 and content sources and curators 908, 910. In still another example, as to the content presentation, the client-side machine may download user preferences which include what source belongs to which bucket. When the client-side machine downloads the story info for each source and curator, it may use the client-side machine's local tables to determine which story should appear in what bucket based on the database relating source and curator to bucket.

The content source 908 may correspond to a web site hosted by an entity, such as a business, an organization such as USPTO.gov, a content provider such as cnn.com and Yahoo.com, a social network website such as Facebook.com, or a content feed source such as tweeter or blogs. The content curators 910 may be individuals, for example, industry experts, editors, and friends, who share stories. Sometimes these individuals may also publish original content—say in their blog.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the DCP processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

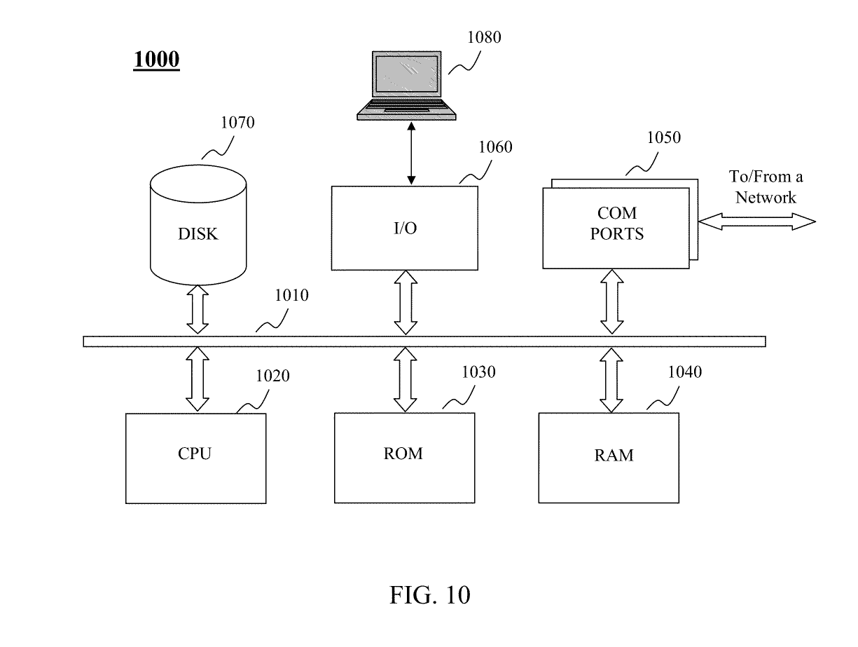

FIG. 10 depicts a general computer architecture on which the present teaching can be implemented and has a functional block diagram illustration of a computer hardware platform that includes user interface elements. The computer may be a general-purpose computer or a special purpose computer. This computer 1000 can be used to implement any components of the content providing architecture as described herein. Different components of the system 100 can all be implemented on one or more computers such as computer 1000, via its hardware, software program, firmware, or a combination thereof. Although only one such computer is shown, for convenience, the computer functions relating to content providing may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU 1004. The computer 1000 also includes an I/O component 1014, supporting input/output flows between the computer 1000 and other components therein such as user interface elements 1016. The computer 1000 may also receive programming and data via network communications.

Hence, aspects of the method of content providing, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method implemented on at least one machine, each of which has at least one processor, storage, and a communication platform connected to a network for providing content to a user, comprising the steps of:
associating the user with a first user group, wherein at least some information of the user corresponds to a first topic associated with the first user group;
determining a second user group based on the first topic associated with the first user group, wherein a second topic associated with the second user group is different from the first topic associated with the first user group; and
providing content related to the second topic associated with the second user group to the user.

2. The method of claim 1, wherein the first topic associated with the first user group and the second topic associated with the second user group are opposite of each other.

3. The method of claim 2, wherein determining a second user group further comprises:
receiving an input from a different user associated with the first user group indicating that the first topic associated with the first user group and the second topic associated with the second user group are opposite of each other.

4. The method of claim 2, wherein determining a second user group further comprises:
checking the first topic associated with the first user group against a knowledge archive to identify the second topic associated with the second user group that is opposite of the first topic associated with the first user group.

5. The method of claim 4, wherein the knowledge archive comprises at least one of encyclopedia, Wikipedia, and a dictionary.

6. The method of claim 1, further comprising simultaneously providing content related to the first topic associated with the first user group to the user.

7. The method of claim 1, wherein the content comprises news.

8. A method implemented on at least one machine, each of which has at least one processor, storage, and a communication platform connected to a network for providing content to a user, comprising the steps of:
providing a plurality of user groups to the user to join, wherein each of the plurality of user groups is associated with a topic;
receiving an input from the user indicating selection of joining a first user group from the plurality of user groups, wherein the first user group is associated with a first topic;
determining a second user group that the user did not select to join, wherein a second topic associated with the second user group is different from the first topic associated with the first user group; and
providing content related to the second topic associated with the second user group to the user.

9. The method of claim 8, wherein the first topic associated with the first user group and the second topic associated with the second user group are opposite of each other.

10. The method of claim 9, wherein determining a second user group further comprises:
receiving an input from a different user associated with the first user group indicating that the first topic associated with the first user group and the second topic associated with the second user group are opposite of each other.

11. The method of claim 9, wherein determining a second user group further comprises:
checking the first topic associated with the first user group against a knowledge archive to identify the second topic associated with the second user group that is opposite of the first topic associated with the first user group.

12. The method of claim 11, wherein the knowledge archive comprises at least one of encyclopedia, Wikipedia, and a dictionary.

13. The method of claim 8, further comprising simultaneously providing content related to the first topic associated with the first user group to the user.

14. The method of claim 9, wherein the content comprises news.

15. A method implemented on at least one machine, each of which has at least one processor, storage, and a communication platform connected to a network for providing content to a user, comprising the steps of:
associating the user with a first user group, where at least some information of the user corresponds to a first topic associated with the first user group;
providing at least a second user group to the user to select, wherein a second topic associated with the second user group is different from the first topic associated with the first user group;
receiving an input from the user indicating selection of the second user group; and
providing content related to the second topic associated with the second user group to the user based on the received input from the user.

16. The method of claim 15, wherein the first topic associated with the first user group and the second topic associated with the second user group are opposite of each other.

17. The method of claim 16, wherein providing at least a second user group to the user further comprises:
receiving an input from a different user associated with the first user group indicating that the first topic associated with the first user group and the second topic associated with the second user group are opposite of each other.

18. The method of claim 16, wherein providing at least a second user group to the user further comprises:
checking the first topic associated with the first user group against a knowledge archive to identify the second topic associated with the second user group that is opposite of the first topic associated with the first user group.

19. The method of claim 15, further comprising simultaneously providing content related to the first topic associated with the first user group to the user.

20. The method of claim 15, wherein the content comprises news.
